(19) United States
(12) Patent Application Publication
(10) Pub. No.: US 2026/0147452 A1
(43) Pub. Date: May 28, 2026

(54) HUMAN-COMPUTER INTERACTION METHOD AND DEVICE

(71) Applicant: Lenovo (Beijing) Limited, Beijing (CN)

(72) Inventors: Fang YUAN, Beijing (CN); Mingjiang FAN, Beijing (CN); Zhe WU, Beijing (CN); Ken WANG, Beijing (CN)

(21) Appl. No.: 19/178,567

(22) Filed: Apr. 14, 2025

(30) Foreign Application Priority Data
Apr. 17, 2024 (CN) 202410466132.7

(51) Int. Cl. G06F 3/0484; G06F 3/0482; G06N 5/02

(52) U.S. Cl. CPC G06F 3/0484; G06F 3/0482; G06N 5/02

(57) ABSTRACT

A human-computer interaction method includes: in response to obtaining first input content, outputting a resulting response corresponding to the first input content in a session window of a first application, where presentation method or operability of the resulting response varies with the first input content.

### RELATED APPLICATION(S)

This application claims priority to Chinese Patent Application No. 202410466132.7 filed with the National Intellectual Property Administration, PRC on Apr. 17, 2024, which is incorporated herein by reference in entirety.

### FIELD OF THE TECHNOLOGY

Embodiments of the present disclosure relate to the field of artificial intelligence, and relate to but are not limited to a human-computer interaction method and device.

### BACKGROUND

The human-computer interactions in certain existing technical solutions are simple question-answering interactions, which may not meet the users'needs for diverse questions and answers.

### SUMMARY

Embodiments of the present disclosure provide a human-computer interaction method, device, equipment, and storage medium.

The technical solution of the embodiments of the present disclosure is implemented as follows:
In one aspect, the present disclosure provides a human-computer interaction method. The method includes in response to obtaining a first input content, outputting a resulting response corresponding to the first input content in a session window of a first application executing an interactive task, where a presentation mode or operability of the resulting response varies with the first input content.

In another aspect, the present disclosure provides a human-computer interaction device. The device includes a first execution module, for, in response to obtaining a first input content, outputting a resulting response corresponding to the first input content in a session window of a first application executing an interactive task, where a presentation method or operability of the resulting response varies with the first input content.

In yet another aspect, the present disclosure provides an electronic device. The device includes a memory storing computer program instructions, and a processor coupled to the memory and configured to execute the computer program instructions to perform: in response to obtaining a first input content, outputting a resulting response corresponding to the first input content in a session window of a first application executing an interactive task, where a presentation mode or operability of the resulting response varies with the first input content.

In yet another aspect, the present disclosure provides a storage medium storing executable instructions for implementing the above method when executed by a processor.

In response to obtaining the first input content, a resulting response corresponding to the first input content is output in the session window of the first application executing the current interactive task. The presentation mode and/or operability of the resulting response corresponding to different first input contents are different. Accordingly, it is possible to present a variety of presentation modes according to different questions asked by users, and the presentation may further achieve different operability to meet the diverse response needs of users.

### BRIEF DESCRIPTION OF THE DRAWINGS

FIG. 1A is a schematic diagram of an implementation process of a human-computer interaction method according to certain embodiments of the present disclosure;

FIG. 1B is a schematic diagram of a session window according to certain embodiments of the present disclosure;

FIG. 1C is a schematic diagram of a session window according to certain embodiments of the present disclosure;

FIG. 1D is a schematic diagram of two display layouts according to certain embodiments of the present disclosure;

FIG. 2A is a schematic diagram of an implementation process of outputting a resulting response according to certain embodiments of the present disclosure;

FIG. 2B is a schematic diagram of two session windows according to certain embodiments of the present disclosure;

FIG. 2C is a schematic diagram of a session window according to certain embodiments of the present disclosure;

FIG. 2D is a schematic diagram of two session windows according to certain embodiments of the present disclosure;

FIG. 2E is a schematic diagram of a session window according to certain embodiments of the present disclosure;

FIG. 2F is a schematic diagram of three session windows according to certain embodiments of the present disclosure;

FIG. 2G is a schematic diagram of a session window according to certain embodiments of the present disclosure;

FIG. 2H is a schematic diagram of a session window according to certain embodiments of the present disclosure;

FIG. 2I is a schematic diagram of a session window according to certain embodiments of the present disclosure;

FIG. 2J is a schematic diagram of a session window according to certain embodiments of the present disclosure;

FIG. 3A is a schematic diagram of an implementation process of a method for deploying a third-party APP (application) and an intent instruction set in the cloud according to certain embodiments of the present disclosure;

FIG. 3B is a schematic diagram of an implementation process of a method for a third-party APP to access an intelligent agent according to certain embodiments of the present disclosure;

FIG. 4 is a schematic diagram of an implementation process of outputting a resulting response according to certain embodiments of the present disclosure;

FIG. 5 is a schematic diagram of a composition structure of a human-computer interaction device according to certain embodiments of the present disclosure; and

FIG. 6 is a schematic diagram of a hardware entity of an electronic device according to certain embodiments of the present disclosure.

### DETAILED DESCRIPTION

To make the purpose, technical solution and advantages of the embodiments of the present disclosure clearer, certain technical solution of the embodiments of the present disclosure is described in detail below in conjunction with the accompanying drawings. The following embodiments are used to illustrate the present disclosure, but are not used to limit the scope of the present disclosure.

Reference is made to “some embodiments” or “certain embodiments”, which describe a subset of all possible embodiments, “some embodiments” or “certain embodiments” may be the same subset or different subsets of possible embodiments and may be combined with each other without conflict.

Terms “first\second\third” are used to distinguish similar objects and do not necessarily represent a specific ordering of the objects. Terms “first\second\third” may be interchanged with a specific order or sequence where permitted, so that the embodiments of the present disclosure described herein may be implemented in an order other than that illustrated or described herein.

Unless otherwise mentioned, technical and scientific terms used herein have the same meaning as those commonly understood in the technical field. The terms used herein are for the purpose of describing the embodiments of the present disclosure and are not intended to limit the present disclosure.

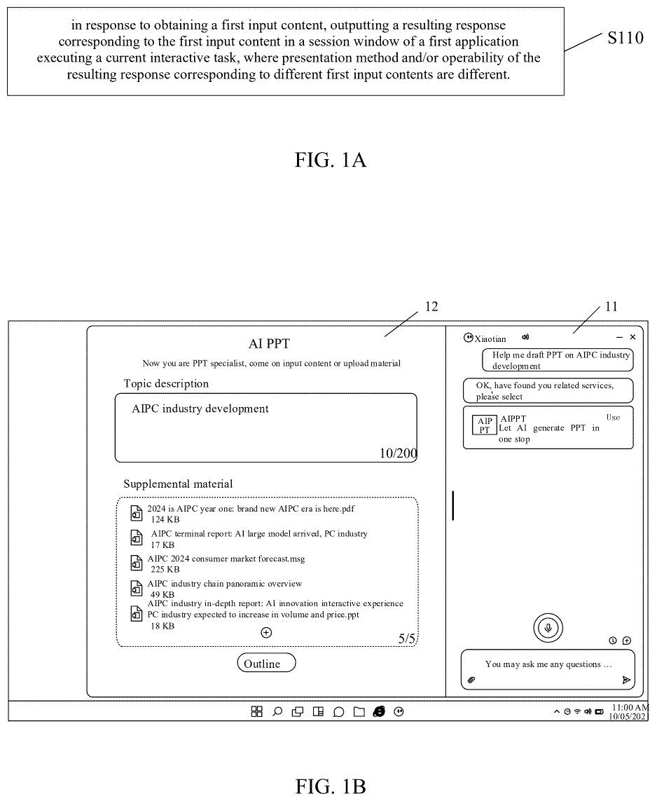

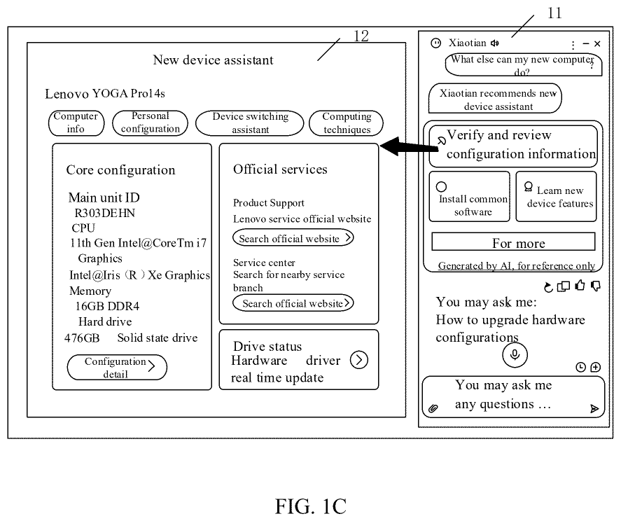

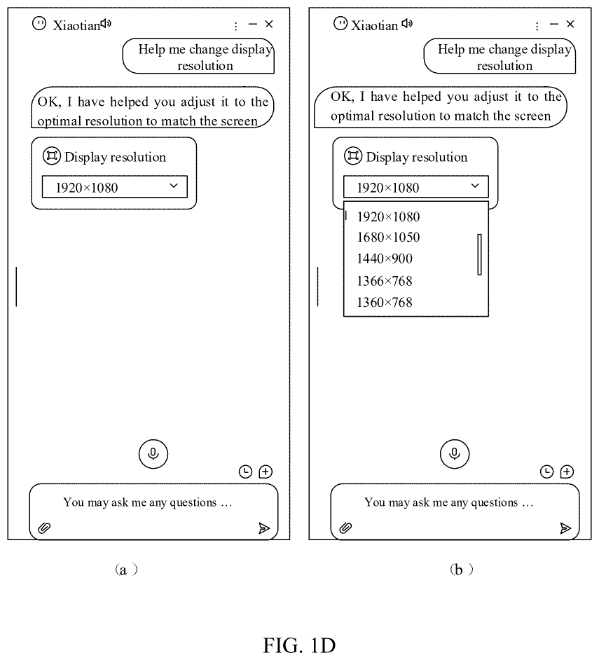

The present disclosure in certain embodiments provides a human-computer interaction method, as shown in FIG. 1A, the method including the following steps.

Step S110, in response to obtaining a first input content, outputting a resulting response corresponding to the first input content in a session window of a first application executing a current interactive task; where presentation method and/or operability of the resulting response corresponding to different first input contents are different.

In certain embodiments, the first input content may be a character string content input into the conversation input box, may be voice content input by voice, may include an input operation, or may be a recognized gesture operation.

The first application may be an AI Agent application that may realize human-computer interaction, or an interactive application that may interact with users, such as a social networking application, a conference application, or an email application, or the like, which may display a session window. In certain embodiments, AI Agent is an intelligent entity that may perceive the environment, make decisions, and perform actions. Unlike traditional artificial intelligence, AI Agent has the ability to gradually perform a given goal by thinking independently and calling tools. In certain embodiments, the first application may also be an application such as a chat assistant, a device assistant, or the like.

The session window of the first application is a window that may interact with the AI Agent. In certain embodiments, the session window may be the main window of the AI Agent or the extended window of the AI Agent.

FIG. 1B is a schematic diagram of a session window provided according to certain embodiments of the present disclosure. As shown in FIG. 1B, the schematic diagram includes a main window 11 and an extended window 12.

Taking FIG. 1B as an example, the AI Agent is given a name “Xiaotian.” The first input content displayed in the main window 11 is “Help me write a PPT about the development of the AIPC industry.” Xiaotian replies “OK, I have found relevant services for you, please select” and provides a “Use” button in the main window 11. The user clicks the “Use” button to display the extended window 12 to generate a PPT that replies to the user's inquiries in the extended window.

FIG. 1C is a schematic diagram of a session window provided in certain embodiments of the present disclosure. As shown in FIG. 1C, the schematic diagram includes a main window 11 and an extended window 12.

Taking FIG. 1C as an example, the first input content displayed in the main window 11 is “What else may I do with my new computer?” Xiaotian replies “Xiaotian recommends a new machine assistant for you, with multiple functions to help you get started with the new machine” and provides a card layout of “Verify configuration”, “Install software”, “New machine tips” and “View more” in the main window 11. The user clicks “Verify configuration” on the card to display various configuration information of the electronic device in the extended window 12.

In certain embodiments, the presentation mode may be a display layout. Different operability may be whether resulting responses of different types or scenarios have operable controls, or whether further operations may be performed.

In certain embodiments, FIG. 1D is a schematic diagram of two display layouts provided in certain embodiments of the present disclosure. As shown in FIG. 1D, the schematic diagram includes sub-figure (a) and sub-figure (b). In sub-figure (a), the user sends “Help me change the display resolution” to Xiaotian, and Xiaotian replies “OK, I have helped you adjust it to the optimal resolution to match the screen” and displays “Display resolution.” The user may further select the appropriate resolution through the drop-down menu shown in sub-figure (b).

In certain embodiments of the present disclosure, in response to obtaining the first input content, a resulting response corresponding to the first input content is output in the session window of the first application executing the current interactive task; where the presentation mode and/or operability of the resulting response corresponding to different first input contents are different. In certain embodiments, it is possible to present a variety of presentation modes according to different questions asked by users, and the presentation may further achieve different operability to meet the diverse response needs of users.

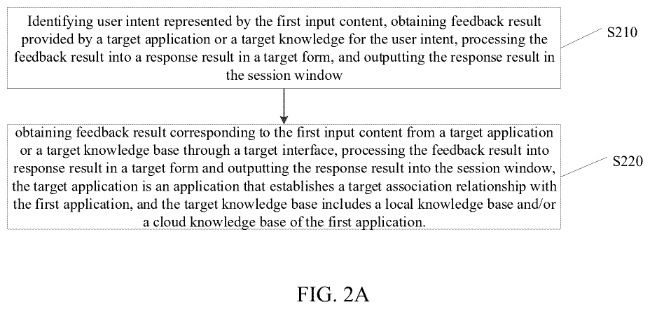

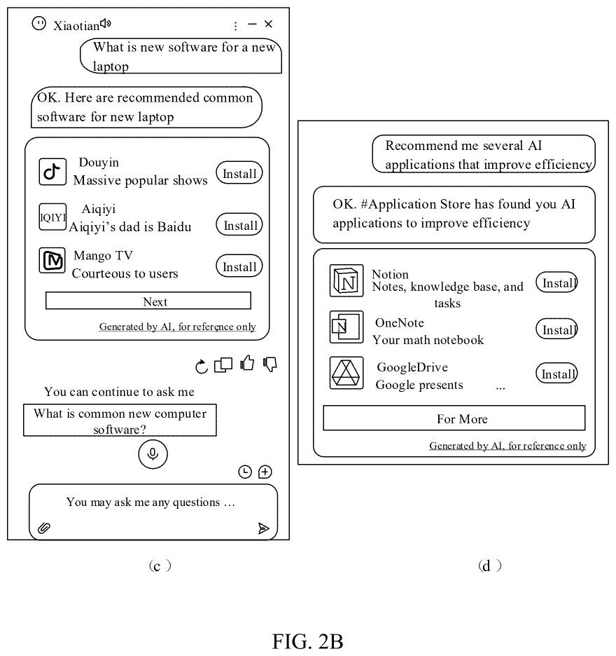

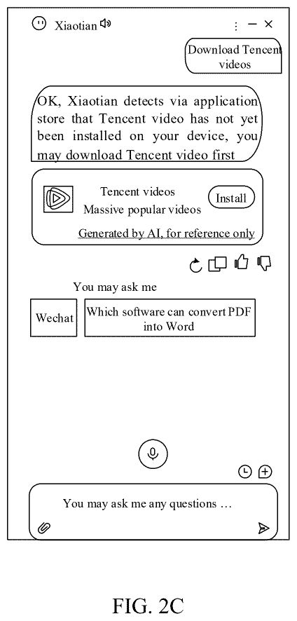

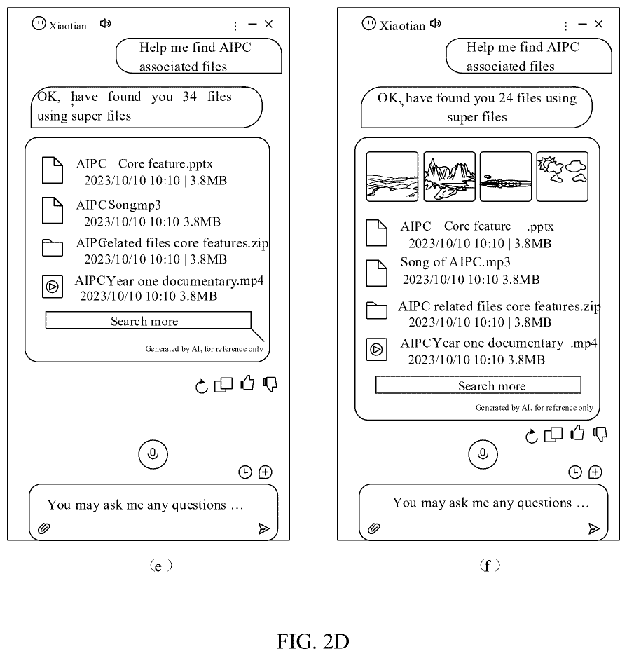

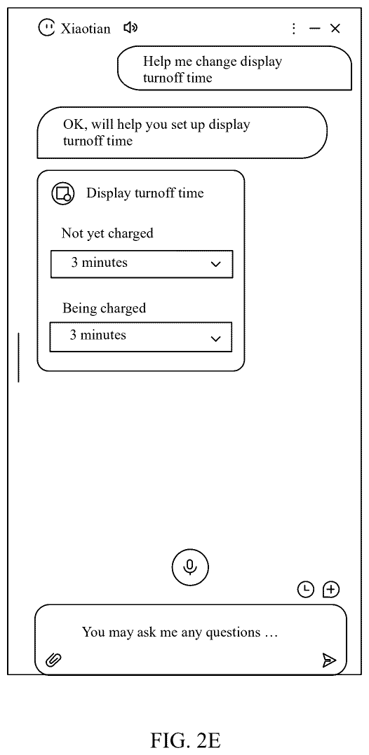

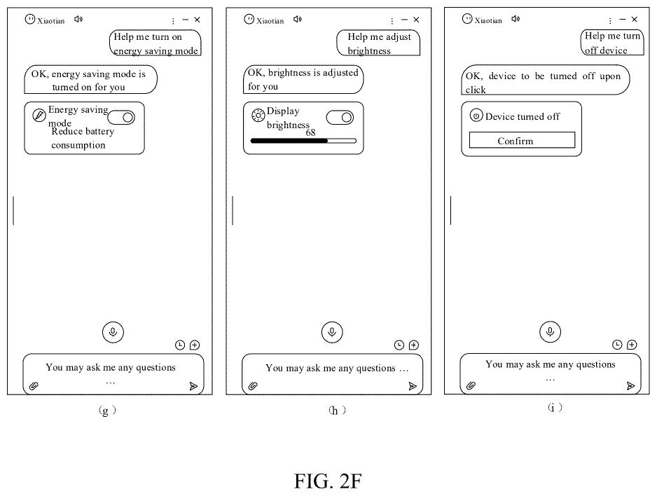

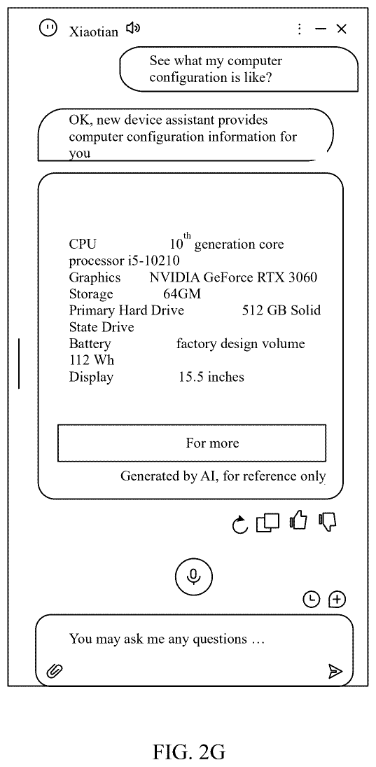

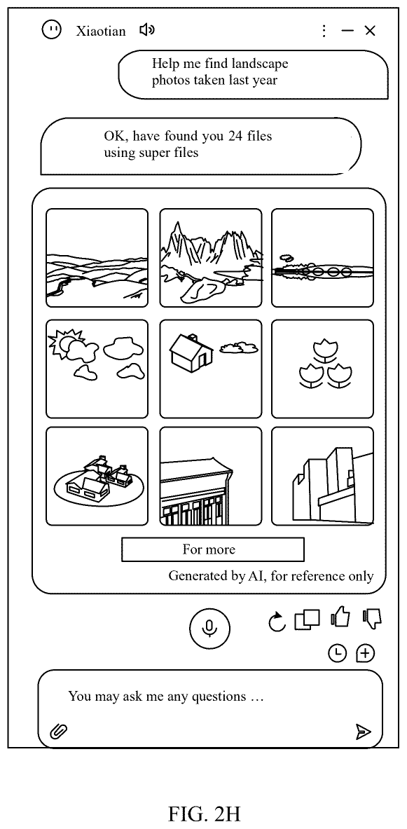

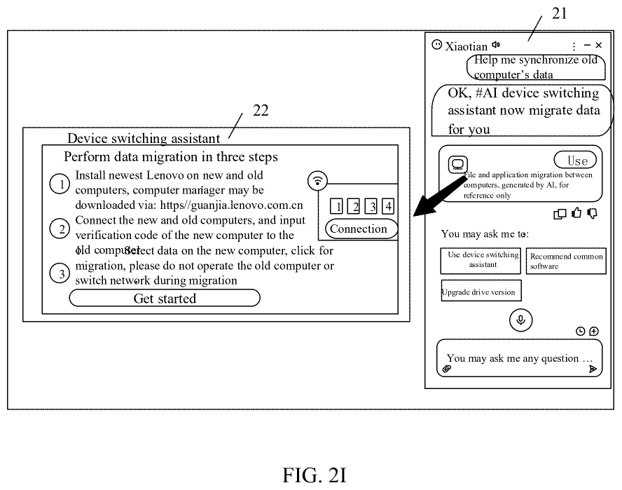

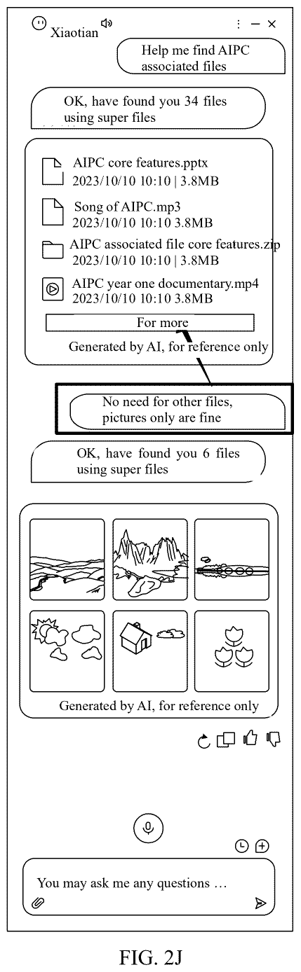

In certain embodiments, as shown in FIG. 2A, at step S110, “outputting a resulting response corresponding to the first input content in a session window of the first application executing the current interactive task” may be implemented by at least one of the following steps:
Step S210: identifying the user intent represented by the first input content, obtaining a feedback result provided by a target application or a target knowledge base for the user intent, processing the feedback result into a resulting response in a target form and outputting the resulting response in the session window.

In certain embodiments, user intent may be simple semantic understanding or may be the recognition of user input through the intent understanding model within the AI Agent.

The target application may be an application that is registered in the first application (such as Xiaotian agent) through a registration interface such as an application programming interface (API) and may interact with Xiaotian through commands and data.

In certain embodiments, the target application may be an application bound to the Xiaotian agent through an API, such as a vantage application (or other device manager applications) that implements device control, an album application, a file manager, an application store that provides software (Application, APP) downloads, a device change assistant, a wallpaper application, or the like. Among them, Vantage is an application that processes computer performance and enables device security protection. In an implementation process, the selection and determination of the target application may depend on the type or semantic content or intent of the first input content.

The target knowledge base includes a local knowledge base and a cloud knowledge base, where the local knowledge base may include a local file library, a local atlas, a local video library, or the like; the cloud knowledge base may include a cloud disk, a file system of a peripheral device, or the like. In an implementation process, the local knowledge base or the cloud knowledge base may also include a peripheral knowledge base located in a peripheral device based on different usage scenarios, such as being determined based on the physical location relationship with the electronic device running the first application. When it is a peripheral device, the peripheral knowledge base may be selected, and when it is a cloud server, the cloud knowledge base may be selected.

The feedback result may be data of any form, such as at least one of a picture, a link, a control icon, a parameter value, a configuration parameter, a configuration option, a processing option, and the like.

The resulting response of a target form may be any one or a combination of cards, atlases, operation windows, links, or the link, converted into corresponding formats based on the type of the feedback result.

In certain embodiments, FIG. 2B is a schematic diagram of two session windows provided in certain embodiments of the present disclosure. As shown in FIG. 2B, the schematic diagram includes sub-figure (c) and sub-figure (d), where, as shown in sub-figure (c), it is recognized that the user's first input content is “What are the commonly used software for new computers?”, then Xiaotian recognizes after intent recognition that the user wishes to recommend some commonly used software on new computers for installation, and then outputs the answer “OK, these commonly used software for new computers have been recommended to you”, and further displays the recommendation card and installation button of the commonly used software, and the user may install the recommended software by clicking the installation button. In certain embodiments, the target application may be an application store. In an implementation process, the installation software link of the application store may be obtained, and based on the installation software link, an installation button is provided to the user in the session window. As shown in sub-figure (d), the first input content of the user is identified as “Help me recommend several AI applications that improve efficiency.” Based on the identification of the user's intent to improve efficiency AI applications, the intent may be given to the associated application from the application store, the relevant information and download link of the recommended AI application fed back by the application store may be obtained, and the AI application recommended by the application store to improve efficiency is displayed in the session window and a button is displayed for installation of the recommended AI application. In certain embodiments, the target application may be an application store. During implementation, an installation software link of the application store may be obtained, and an installation button may be provided to the user in the session window based on the installation software link.

Step S220: obtaining feedback result corresponding to the first input content from a target application or a target knowledge base through a target interface, processing the feedback result into resulting response in a target form and outputting the resulting response into the session window.

In certain embodiments, the target application is an application that establishes a target association relationship with the first application, and the target knowledge base includes a local knowledge base and/or a cloud knowledge base of the first application.

In certain embodiments, the target interface may be the interface used by the target application, such as a photo album, device management application, or the like, for registration to the first application (Xiaotian intelligent agent), such as the corresponding API interface.

In an implementation process, the feedback result corresponding to the first input content is obtained from the target application or target knowledge base through the target interface. In certain embodiments, the first input content may be obtained without identifying the user's intent. It is analyzed as to which target application or which knowledge base the first input content corresponds to, and the call instruction or search instruction corresponding to the first input content is transmitted to the relevant target application or target knowledge base. In certain embodiments, FIG. 2C is a schematic diagram of the session window provided in certain embodiments of the present disclosure. As shown in FIG. 2C, when it is recognized that the user inputs “Download Tencent Video,” “Download Tencent Video” may be directly given to the application store application. The application store recognizes and provides the download and installation link of Tencent Video by matching “Tencent Video” and feedback the installation link to Xiaotian. Xiaotian processes the feedback result into a resulting response in the form of a card and displays feedback result to the user. As may be seen in the figure, Xiaotian replies, “Okay, Xiaotian detects through the application store that Tencent Video has not been installed on your device. You may download Tencent Video first.” The installation button of Tencent Video is further displayed, and the user may install Tencent Video by clicking the installation button.

FIG. 2D is a schematic diagram of two session windows provided in certain embodiments of the present disclosure. As shown in FIG. 2D, the schematic diagram includes sub-figure (e) and sub-figure (f), where, as shown in sub-figure (e), the first input content is “Help me find AIPC-related files,” which may be matched with “AIPC” to enable the user to query different types of corresponding files in the electronic device. Therefore, the various related files found are displayed in the form of a file list, and a link to each corresponding file is displayed, so that the user may see the corresponding file in the session window and view the corresponding file by clicking the link. As shown in sub-figure (f), the first input content is “Help me find files related to AIPC,” which may match “AIPC” to enable the user to query different types of corresponding files and pictures in the electronic device, and display the corresponding files and pictures in the form of a file library.

The target form may be in different card forms, atlas forms, link forms or other layout forms, and each card may be regarded as a loaded H5 component. In certain embodiments, H5 is a standard computer language for making World Wide Web pages, which is a simplified vocabulary from HTML5. H5 components refer to components written in HTML5 language.

In certain embodiments of the present disclosure, the feedback result may be obtained by identifying the user intent represented by the first input content; the feedback result corresponding to the first input content may also be obtained from the target application or target knowledge base through the target interface. In certain particular embodiments, the feedback result may be obtained by identifying the user intent or matching the first input content, and the feedback result may be processed into a resulting response and displayed in the session window, thereby improving the accuracy and diversity of the reply to the first input content, expanding on the content of the reply, and meeting the different reply desirables of users. The feedback results may be processed into the target form and displayed in the session window, so that users may perform the operations in one session window without having to jump to other pages, allowing users to directly see the feedback results in the form of dialogue, thereby improving user convenience.

In certain embodiments, at step S110, “outputting a resulting response corresponding to the first input content in the session window of the first application executing the current interactive task” may also be implemented by the following steps:
Step S230: determining a target application or a target knowledge base that corresponds to the first input content based on the first input content, and loading a target response component of the target application or the target knowledge base into the first application, to process the feedback result into a resulting response in a target form and display the resulting response in the session window through the target response component.

During implementation, one or more of keyword matching, user habits, and device configuration may be considered to determine a corresponding target application or target knowledge base to respond to the first input content.

In certain embodiments, the target response component may be a component used by each application to be presented in the session window, such as a card, a pop-up window, and the like.

At step S230, “Determining a target application or a target knowledge base corresponding to the first input content based on the first input content” may be implemented by at least one of the following steps:
Step 231: Identifying a target keyword in the first input content, and determining a target application or target knowledge base corresponding to the target keyword based on the target keyword;

In certain embodiments, the target keyword may be, in certain embodiments, a keyword carrying an application name or a knowledge base, a keyword representing a functional requirement, or the like.

In certain embodiments, as shown in FIG. 2C, the target keyword “Tencent Video” may be identified based on the first input content “Download Tencent Video”, and based on this “Tencent Video,” the matching target application is determined to be an application store application that provides a link to install Tencent Video, such as Lenovo App Store and App Store.

Step 232: Obtaining user portrait data of a target user who inputs the first input content, and determining a target application or target knowledge base corresponding to the user portrait data based on the user portrait data.

In certain embodiments, user portrait data includes user habit data or user historical behavior data, or the like.

In certain embodiments, the first input content input by the user is to search for a picture, and then based on the user's habits or historical behaviors, it is determined that the user often views pictures from an album application, and the album application may be determined as the target application;

In certain embodiments, when it is determined based on user habits or historical behaviors that the user often views images from a cloud gallery, the cloud gallery may be determined as a target knowledge base that corresponds to the user.

Step 233: determining a target application or target knowledge base corresponding to the user intent represented by the first input content.

In certain embodiments, as shown in sub-figure (d) of FIG. 2B, the first input content is “Recommend me several AI applications that improve efficiency.” Based on the recognition that the user intent is that the user wants to install AI applications that improve efficiency, the application store application that provides AI applications may be determined as the target application that corresponds to the user intent.

Step 234: Determining the target application or target knowledge base based on the first input content and configuration information of the electronic device running the first application.

In certain embodiments, the user enters “Please help me process this video” in Xiaotian's session window, and Xiaotian accesses three applications that may edit or generate the video. However, in view of the configuration information of the electronic device, the first application may have too high requirements on the device's configuration resources. Therefore, the second or third application among the three applications may be selected as the target application.

In certain embodiments of the present disclosure, by identifying the target keywords of the first input content, or determining the user's intent based on user portrait data, or through the first input content, or based on the first input content or the configuration information of the electronic device, a suitable target application or target knowledge base may be determined and provided to the user, which may improve the diversity and accuracy of recommendations.

In certain embodiments, at steps S210 and S220, “Processing the feedback result into a resulting response in a target form and outputting the resulting response in the session window” may be implemented by at least one of the following steps:
Step 211: Using the target response component of the target application or the target knowledge base to process the feedback result into a resulting response in the form of a card and output the resulting response in the session window.

In certain embodiments, the target response component is a front-end component for displaying the feedback result of the target application or target knowledge base on the first application, such as an H5 component or other HTML component.

The card form may be a card form display of multiple different types of files in the session window as shown in sub-figure (e) of FIG. 2D. The different types of files may come from the target knowledge base, and the related file links in the target knowledge base are output as card components. As shown in FIG. 2C, the Tencent video may come from a target application such as an application store, and the link to install the Tencent video may be output as a card component in the session window.

FIG. 2G is a schematic diagram of the session window provided in certain embodiments of the present disclosure. As shown in FIG. 2G, based on the first input content “See what my computer configuration is like?”, the feedback results queried from the configuration information may be processed into a card form and displayed in the session window in the form of a card component.

During implementation, the feedback result is processed into a resulting response in the form of a card and outputted in the session window, including in the main window of the session window, and/or in the extended window. As shown in FIG. 1B, the response component of the resulting response “PAPPT” may be displayed in the form of a card in the main window 11, and the response components of “Topic description” and “Supplementary materials” may be displayed in the form of cards in the extended window 12, respectively.

Step 212: Processing the feedback result into a resulting response in the form of a control and outputting the resulting response in the session window.

In certain embodiments, the control form may correspond to the device control class or configuration item setting, download and installation, or the like.

FIG. 2F is a schematic diagram of three session windows provided in certain embodiments of the present disclosure. As shown in FIG. 2F, the schematic diagram includes sub-figure (g), sub-figure (h) and sub-figure (i). As shown in sub-figure (g), a control form of an operation switch may be provided in the session window, and the user chooses to turn on or off to turn the energy-saving mode on or off. As shown in sub-figure (h), a control form of an operation switch and a slider bar may be provided in the session window, and the user may select the switch to adjust the brightness, and further adjust the brightness value by adjusting the slider bar. As shown in sub-figure (i), a control form of an operation switch may be provided in the session window, and the user may click the confirmation switch to confirm the shutdown operation.

Step 213: Processing the feedback result into a resulting response in the form of a snapshot and output the resulting response in the session window.

In certain embodiments, the snapshot form may be a presentation of the corresponding atlas or document result.

FIG. 2H is a schematic diagram of the session window provided in certain embodiments of the present disclosure. As shown in FIG. 2H, based on the first input content “Help me find the landscape photos taken last year,” the feedback results may form an album and be presented as thumbnails.

As shown in sub-figure (e) of FIG. 2D, based on the first input content “Help me find AIPC-related files,” the feedback result may be presented in the session window as a document result.

Step 214: Processing the feedback result into a resulting response in the form of a hyperlink and output the resulting response in the session window.

In certain embodiments, the hyperlink form may correspond to the presentation of results such as a web page, an access address, or the like.

As shown in sub-figure (d) of FIG. 2B, based on the first input content “Recommend me several AI applications that improve efficiency,” the feedback result may be processed into a hyperlink form of a download address and output in the session window.

Step 215: Processing the feedback result into a resulting response in the form of a file library and outputting the resulting response in the session window.

In certain embodiments, the file library form may correspond to the presentation of results of combining pictures and texts and different types of file collections.

As shown in sub-figure (f) of FIG. 2D, based on the first input content “Help me find files related to AIPC,” the feedback results may be processed into pictures and file collections of different types and output in the session window.

In certain embodiments of the present disclosure, the feedback results may be output in the session window in the form of cards, controls, snapshots, hyperlinks, and/or file libraries according to different feedback result types, thereby enriching the diversity of displaying resulting responses and providing a response form that is more in line with the feedback results.

In certain embodiments, at steps S210 and S220, “Processing the feedback result into a resulting response in a target form and outputting the resulting response in the session window” may be implemented by at least one of the following steps:
Step 216: Based on the attribute information of the feedback result, processing the feedback result into a resulting response in a target form corresponding to the attribute information and outputting the resulting response into the main window and/or the extended window of the session window.

In certain embodiments, the attribute information of the feedback result may be the type of the feedback result. In certain embodiments, the type includes at least documents, pictures, device configuration information, applications to be called, or device control options and configuration options to be presented. During implementation, the display form (target form) of the resulting response may be determined based on the herein types. In certain embodiments, it is considered as to whether the feedback result awaits further user operation feedback to decide whether the resulting response is processed into a form with operable controls. In certain embodiments, when the feedback result is a display picture or device configuration information, the resulting response is a card or small window without operable controls; when the feedback result is a device control option or a configuration option, the resulting response is processed into a card or small window with operable controls.

The main window may be the initial session window of the agent (Xiaotian), and the extended window may be a window extended from the initial session window upward, downward, leftward, and rightward. The extended window may pop up automatically or based on user operations.

Step 217: Based on the user portrait information of the target user, processing the feedback result into a resulting response in the target form and outputting the resulting response in the main window and/or extended window of the session window.

In certain embodiments, the user portrait information may include or reflect the user's habits or the user's historical operation data.

During an implementation process, a form that the user often uses may be output based on the user portrait information. In certain embodiments, when the user is accustomed to using a slider control, a control class tab or window with a slider control may be output.

Step 218: Processing the feedback result into a resulting response in a target form based on the data volume of the feedback result and outputting the resulting response in the main window and/or the extended window of the session window;

In certain embodiments, the resulting response is output in the main window and/or the extended window based on the amount of data or the size of the data. In certain embodiments, when the amount of data is small, the resulting response may be fully displayed in the main window and/or the extended window; when the amount of data is large, the resulting response may be displayed in a folded or thumbnail format, and the control icon or logo of “show more” may be used to display in full or turn the page or call up the extended window for display.

Step 219: Based on the working status of the electronic device and/or the first application, processing the feedback result into a resulting response in a target form and outputting the resulting response in the main window and/or the extended window of the session window. The electronic device is a device running the first application.

In certain embodiments, the resulting response may be output in the main window and/or the extended window of the session window based on whether there are multiple tasks being executed concurrently in the agent and whether there are other applications running concurrently in the electronic device. In certain embodiments, when both the electronic device and/or the agent are in an idle state, the resulting response may be output in a large size and in an extended window; but when the electronic device and/or the agent are in a busy state, a small size may be selected to be displayed in the main window.

In certain embodiments of the present disclosure, it may be determined based on at least one of the following: attribute information of the feedback result, user portrait information of the target user, the data volume of the feedback result, the working status of the electronic device and/or the first application, to process the feedback result into a resulting response in the target form and output the resulting response in the main window and/or extended window of the session window. The target form of the resulting response in the main window and/or extended window may be determined more reasonably, so that the display of the resulting response satisfies different display requirements and users are provided with a variety of display main windows and/or extended windows.

As shown in sub-figure (d) of FIG. 2B, the user may ask the question “Recommend me some AI applications that improve efficiency” in Xiaotian's session window; Xiaotian's intent understanding model recognizes the action instructions of Lenovo App Store and loads the components corresponding to the instructions into Xiaotian's dialog box; Xiaotian's framework provides an interface to support two-way communication between components and Lenovo App Store APP, and performs the installation, progress, and opening of related software.

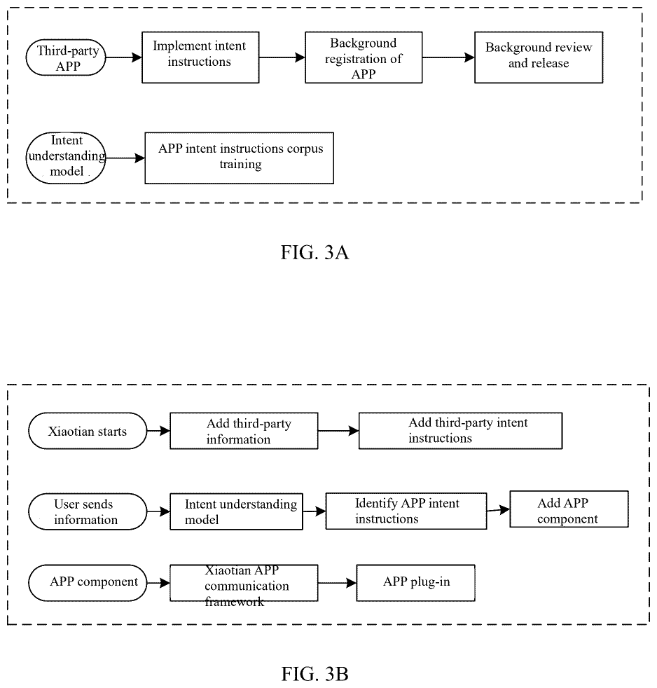

The present disclosure in certain embodiments provides a method for deploying a third-party APP (application) and an intent instruction set in the cloud. As shown in FIG. 3A, the third-party APP may be deployed in the cloud by implementing the steps of implementing intent instructions, background registration of the APP, and background review and release; the intent understanding model may be obtained by training the APP intent instruction corpus and deployed in the cloud.

During an implementation process, third-party APPs may develop Xiaotian's command components and plug-ins based on the access specifications of Xiaotian's third-party APPs, register and publish CoreApp application in the background, and train the intent understanding model based on the corpus provided by the APP.

The present disclosure in certain embodiments provides a method for a third-party APP to access an intelligent agent. As shown in FIG. 3B, when the intelligent agent Xiaotian is started, the third-party APP information and the third-party APP intent instruction set may be obtained from the cloud and loaded into the intelligent agent Xiaotian. When a user sends a message to Xiaotian, the intent understanding model may be used to identify the APP intent instruction, and the APP component may be loaded based on the recognition result. The APP component may establish a connection with the APP plug-in through the Xiaotian APP communication framework to provide the user with a software installation function corresponding to the installation button shown in FIG. 2C.

During an implementation process, after Xiaotian is started, the information and instruction set information of the third-party APP are loaded. After the user sends a message in Xiaotian's session window, when the intent understanding model recognizes the instruction of the third-party APP, the component of the APP is loaded, and a series of framework interfaces are provided for the component to perform the two-way communication between the component and the APP.

Natural language dialogue based on the intelligent agent Xiaotian may be realized, relying on the intent understanding ability of the model, so that third-party APPs may be quickly connected to the intelligent agent Xiaotian in a component manner.

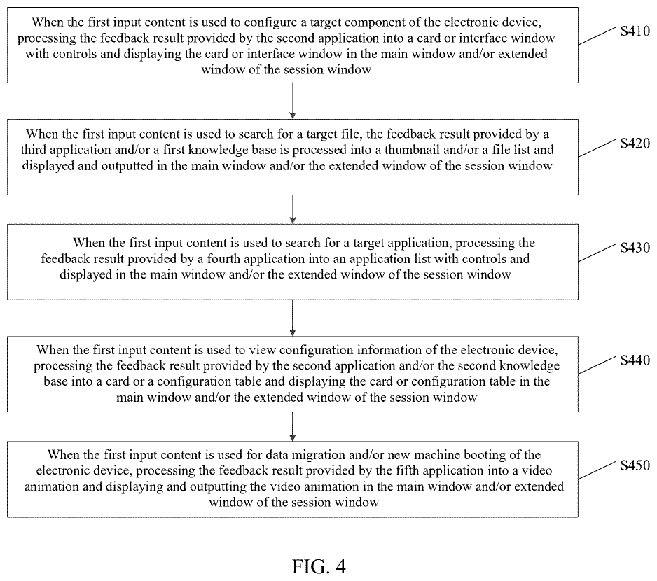

In certain embodiments, as shown in FIG. 4, at step S110, “Outputting a resulting response corresponding to the first input content in a session window of the first application executing the current interactive task” may be implemented by at least one of the following steps:
Step S410: When the first input content is used to configure a target component of the electronic device, processing the feedback result provided by the second application into a card or interface window with controls and displaying the card or interface window in the main window and/or extended window of the session window.

In certain embodiments, the target components include hardware and software, such as configuration items of the electronic device, such as in particular the resolution and brightness of the display, the volume of the speaker and microphone, the hard disk read and write speed, the application window size, startup items, permission configuration, or the like.

The second application may be an application capable of managing the configuration of the target component, such as Lenovo's Vantage software, Lenovo Manager, Tencent Manager, 360 Manager, or the like.

The form of the control is not limited, such as a switch button, a slider, a drop-down box, or the like. The interface window includes an input box or an On-Screen Display (OSD) pop-up window.

In certain embodiments, sub-figure (b) in FIG. 1D shows that the display resolution is adjusted by using a drop-down box in the session window. Sub-figure (g) in FIG. 2F shows that a toggle switch is used in the session window to determine whether to turn on the energy saving mode. Sub-figure (h) in FIG. 2F shows that the screen brightness may be adjusted by using a slider in the session window. Sub-figure (i) in FIG. 2F shows that a confirmation button may be clicked in the session window to confirm the shutdown operation.

Step S420: When the first input content is used to search for a target file, the feedback result provided by a third application and/or a first knowledge base is processed into a thumbnail and/or a file list and displayed and outputted in the main window and/or the extended window of the session window.

In certain embodiments, the third application may be an application such as a file manager, a super file, a photo album, or the like. The first knowledge base may be pictures or files stored in the cloud or a cloud disk.

During an implementation, the feedback result may be processed into a collection of thumbnail sets and/or file lists.

In certain embodiments, the session window shown in FIG. 2H may display a collection of thumbnails of pictures, where the displayed pictures may be from applications such as a local photo album or a cloud photo album, or the like. The session window shown in sub-figure (e) of FIG. 2D may display a collection of file lists, where the displayed files may be from applications such as a file manager or a super document, or the like. The session window shown in sub-figure (f) in FIG. 2D may display a collection of thumbnail sets and file lists, where the displayed pictures may be from applications such as local photo albums or cloud photo albums, and the displayed files may be from applications such as file managers or super documents.

Step S430: When the first input content is used to search for a target application, processing the feedback result provided by a fourth application into an application list with controls and displayed in the main window and/or the extended window of the session window.

In certain embodiments, the fourth application may be similar to an application of an application store. The control may be a control that provides a download link, and after the user clicks the control, the user may be directly linked to the application store or the official download address through a related plug-in, providing a download and installation service.

In certain embodiments, a download link control (installation control) may be provided in the session window shown in FIG. 2C. After the user clicks the installation control, the user may be directly connected to the fourth application (application store or official download address) through a related plug-in which provides download and installation services.

Step S440: When the first input content is used to view configuration information of the electronic device, processing the feedback result provided by the second application and/or the second knowledge base into a card or a configuration table and displaying the card or configuration table in the main window and/or the extended window of the session window;

In certain embodiments, the configuration information of the electronic device includes the configuration information of the local device or the configuration information of other devices such as peripheral devices, or the like. The card or configuration table is not limited to displaying the configuration information of the electronic device, and may also be used to display results in other scenarios.

In certain embodiments, in FIG. 2G, the first input content is “See how my computer is configured?”. The configuration information of the electronic device provided by the second knowledge base (computer configuration information) or the second application (application such as computer manager) may be processed into a configuration table and displayed in the session window. When more configuration information is to be viewed, the “view more” button may be clicked to view more configuration information.

Step S450: When the first input content is used for data migration and/or new machine booting of the electronic device, processing the feedback result provided by the fifth application into a video animation and displaying and outputting the video animation in the main window and/or extended window of the session window.

In certain embodiments, data migration may be implemented using application software such as a device switching assistant. The fifth application may be a device switching assistant application or a data migration application.

In certain embodiments, when a user wants to switch change a device, a device switching assistant application or a data migration application may be processed into a video animation and displayed in the main window and/or extended window of the session window. FIG. 2I is a schematic diagram of a session window provided in certain embodiments of the present disclosure. As shown in FIG. 2I, the first input of the session window in the schematic diagram is “Help me synchronize the data of the old computer,” and the fifth application may be a device switching assistant, which processes the feedback provided by the device switching assistant into a card displaying the use of a button and outputs the card to the main window 21, and displays and outputs the processed video animation in the extended window 22.

In certain embodiments of the present disclosure, the output form of the feedback result may be determined based on different first input contents, so that the output form of the feedback result is more consistent with the corresponding first input content, and the display form is more diverse and reasonable.

In certain embodiments, the human-computer interaction method further includes one or more of the following steps:
Step S120, in response to obtaining the second input content, updating the corresponding resulting response in the session window and/or controlling the electronic device to perform a target operation in response to the second input content.

In certain embodiments, the second input content may be or may not be related to the resulting response. In certain embodiments, the second input content may be an input operation for a control in the resulting response, or new content re-entered into the input box through a microphone.

In certain embodiments, as shown in sub-figure (c) of FIG. 2B, the second input content may be a prompt given by the agent to the user based on the first input content, “You may continue to ask me: what are the commonly used software for a new computer?”, and then the corresponding resulting response may be updated in the session window. As shown in FIG. 2C, the second input content may also be another prompt given by the agent to the user, “You may continue to ask me: WeChat, what software may convert PDF to World?”, and then the corresponding resulting response of the second input content may be updated in the session window, so that, in an implementation process, a continuous dialogue effect may be formed.

FIG. 2J is a schematic diagram of the session window provided in certain embodiments of the present disclosure. As shown in FIG. 2J, the second input content in the schematic diagram is “No need for other files, just find pictures,” then the resulting response corresponding to the second input content may be updated in the session window to “OK, use super file to find 6 files for you,” and the corresponding 6 picture thumbnails are displayed in the session window.

Updating the resulting response in the session window and/or controlling the electronic device to perform the target operation in response to the second input content may be based on the association between the second input content and the first input content, to update the data content or control state of the resulting response, or regenerate a new resulting response; or, based on the second input content or input operation, the electronic device is controlled to perform a target impact operation, such as controlling the electronic device to shut down, restart, change brightness and volume, disconnect from the network, enter safe mode, or the like.

In certain embodiments, as shown in sub-figure (g) of FIG. 2F, the electronic device may be controlled to turn on the energy saving mode based on the target operation of turning on the energy saving mode selected by the user. As shown in sub-figure (h) of FIG. 2F, the screen brightness of the electronic device may be adjusted based on the target operation of adjusting the screen brightness selected. As shown in sub-figure (i) of FIG. 2F, the electronic device may be controlled to shut down based on the target operation of executing shutdown for confirmation.

In certain embodiments, as shown in the schematic diagram of the session window in FIG. 2E, the screen-off time data often used by the user may be determined first, and the often used screen-off time data may be sorted based on the usage time to obtain a target time value with the longest usage time. In a non-limiting scenario, when the target time value is determined to be 3 minutes, the user may be provided with a screen-off time of 3 minutes when not charged and a screen-off time of 3 minutes when charging.

In certain embodiments, the screen off time that the user is accustomed to may also be determined based on the user portrait data, and then the default screen off time of the device may be modified based on the screen off time that the user is accustomed to.

In certain embodiments of the present disclosure, in response to obtaining the second input content, the resulting response is updated in the session window and/or the electronic device is controlled to perform a target operation in response to the second input content. The resulting response may be updated and/or the target operation may be performed based on the second input content, which further enriches the functional diversity of the agent.

In certain embodiments, step S120 may be implemented by at least one of the following steps:
Step 121: when the second input content includes an input operation on a control in the resulting response corresponding to the first input content, updating the display state of the control in the session window and controlling the electronic device to perform a target operation corresponding to the input operation.

In certain embodiments, the input operation of the control may be an operation of clicking a download control, an operation of clicking a switch, a slider, or a drop-down box, or an operation of clicking “more,” and the like.

The display status includes “On or enable,” “Off or disable,” downloaded, expanded, or the like; the corresponding target operations may be changing brightness, volume, enabling, changing wallpaper, or the like.

In certain embodiments, the second input content may be the opening operation on the control of whether to turn on the “eye protection mode” in the card control displayed in the main window of Xiaotian after the first input content “My eyes are a little tired,” updating the state of the switch control of the “eye protection mode” in the main window to the “on or enable” state, and controlling the electronic device to execute the operation of turning on the eye protection mode.

Step 122: when the second input content has a first association relationship with the first input content, updating the display state and/or display content of the resulting response in the session window.

In certain embodiments, the first association relationship may represent that the second input content is related to the first input content, and the display state may be that the card size becomes larger or smaller, the main window and the extended window are switched, the transparency is adjusted, the position changes, or the like; the results of further expansion or further summary may be considered in relation to the display content change.

In certain embodiments, as shown in FIG. 2H, the second input content is “View more” which is related to the first input content “Help me find the landscape photos taken last year.” When the main window does not display more pictures, the extended window may be presented to display more pictures.

In certain embodiments, as shown in FIG. 2H, the second input content may be an input operation of a “View more” control in a response card displayed on the first input content “Help me find the landscape photos I took last year.” The updated display status of the “View more” control may be displayed in the session window, and the electronic device may be controlled to perform a target operation of viewing more pictures that correspond to the control, such as displaying more landscape photos and changing the position of the “View more” control, or no longer displaying it.

Step 123: When the second input content has a second association relationship with the first input content, regenerating a resulting response in the session window or controlling the electronic device to perform a corresponding target operation.

In certain embodiments, the first association relationship may represent that the second input content is independent of the first input content, and the second input content may be responded to in a manner similar to the manner the first input content is responded to.

In certain embodiments, as shown in FIG. 2C, when the user determines the second input content “What software may convert PDF to World” is unrelated to the first input content, and a PDF to World application status installation link may be provided for the second input content in a manner similar to how Tencent video installation software is provided.

In certain embodiments of the present disclosure, it is possible to update the display status of the control and execute a matching target operation based on the input operation of the control in the resulting response; when the second input content is associated with the first input content, the display status and/or display content of the resulting response is updated in the session window; when the second input content is not associated with the first input content, the resulting response is regenerated in the session window or the target operation is executed, in that a new resulting response is generated and displayed.

In certain embodiments, the human-computer interaction method includes one or more of the following steps:
Step S130: In response to establishing a connection with a target terminal device, displaying and outputting the target terminal device in the session window, to control the target terminal device to perform a corresponding operation based on a third input content acting in the session window, or, in response to a target execution from the terminal device, directing a response operation.

In certain embodiments, the target terminal device may be another device that is connected to the electronic device. In certain embodiments, after the devices are interconnected, the other interconnected terminal devices may be displayed in the session window of the agent of the electronic device, so that the other terminal devices may be controlled by the agent of the electronic device, or may be controlled by the other terminal devices through the agent of the electronic device.

In certain embodiments, the target terminal device may be a Bluetooth speaker, a projection device, or an extended screen. After being interconnected with the electronic device, the interconnected Bluetooth speaker, projection device or extended screen may be displayed in the session window of the intelligent body of the electronic device to control the Bluetooth speaker, projection device, or extended screen through the intelligent body of the electronic device.

When the target terminal device is a server or other electronic device on the network side, after interconnection with the electronic device, the interconnected server or other electronic device may be displayed in the session window of the intelligent body of the electronic device, and the server or other electronic device may be controlled through the intelligent body of the electronic device.

In certain embodiments of the present disclosure, it is possible to display the target terminal device in a session window when the electronic device establishes a connection with the target terminal device, and control the target terminal device to perform an operation based on a third input content acting in the session window, or perform a response operation in response to a target from the target terminal device.

The present disclosure in certain embodiments provides a human-computer interaction device, which includes the modules included, each module includes each submodule, each submodule includes a unit, which may be implemented by a processor in an electronic device; the module or unit may also be implemented by a specific logic circuit; in an implementation process, the processor may be a central processing unit (CPU), a microprocessor (MPU), a digital signal processor (DSP) or a field programmable gate array (FPGA), or the like.

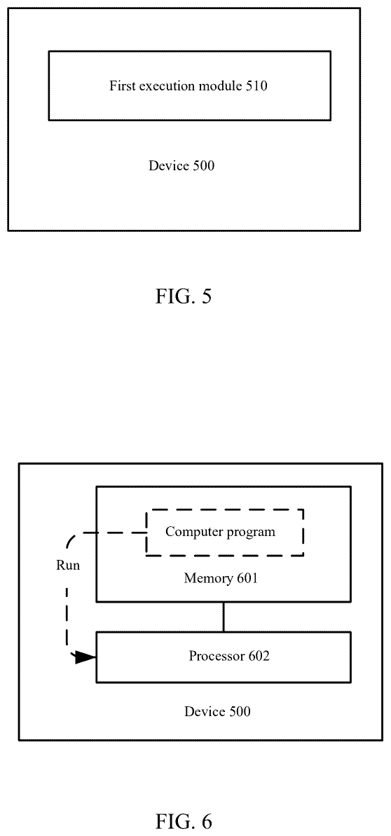

FIG. 5 is a schematic diagram of the composition structure of a human-computer interaction device provided in certain embodiments of the present disclosure. As shown in FIG. 5, the device 500 includes:
A first execution module 510, to output a resulting response corresponding to the first input content in a session window of a first application executing a current interactive task in response to obtaining the first input content; where the presentation method and/or operability of the resulting response corresponding to different first input contents are different.

In certain embodiments, the first execution module 510 includes at least one of the following submodules: a first execution submodule and a second execution submodule, where the first execution submodule is used to identify the user intent represented by the first input content, obtain the feedback result provided by the target application or the target knowledge base for the user intent, and process the feedback result into a resulting response in the target form and output the resulting response in the session window; the second execution submodule is used to obtain feedback result corresponding to the first input content from a target application or a target knowledge base through a target interface, and process the feedback result into a resulting response in a target form and output the resulting response in the session window; where the target application is an application that establishes a target association relationship with the first application, and the target knowledge base includes a local knowledge base and/or a cloud knowledge base of the first application.

In certain embodiments, the first execution module 510 further includes a third execution submodule, which is used to determine a target application or target knowledge base corresponding to the first input content based on the first input content, and load a target response component of the target application or the target knowledge base into the first application, to process the feedback result into a resulting response in a target form and display the resulting response in the session window through the target response component; the third execution submodule includes at least one of the following units: a first determination unit, a second determination unit, a third determination unit, and a fourth determination unit, where the first determination unit is used to identify a target keyword in the first input content, and determine a target application or target knowledge base corresponding to the target keyword based on the target keyword; the second determination unit is used to obtain user portrait data of a target user who inputs the first input content, and determine a corresponding target application or target knowledge base based on the user portrait data; the third determination unit is used to determine a corresponding target application or target knowledge base based on the user intent represented by the first input content; and the fourth determination unit is used to determine the target application or target knowledge base based on the first input content and configuration information of the electronic device that runs the first application.

In certain embodiments, “processing the feedback result into a resulting response in a target form and outputting the resulting response in the session window” in the first execution submodule and the second execution submodule includes at least one of the following units: a first output unit, a second output unit, a third output unit, a fourth output unit, and a fifth output unit, where the first output unit is used to process the feedback result into a resulting response in a card form and output the resulting response in the session window using the target response component of the target application or the target knowledge base; the second output unit is used to process the feedback result into a resulting response in a control form and output the resulting response in the session window; the third output unit is used to process the feedback result into a resulting response in a snapshot form and output the resulting response in the session window; the fourth output unit is used to process the feedback result into a resulting response in a hyperlink form and output the resulting response in the session window; the fifth output unit is used to process the feedback result into a resulting response in a file library form and output the resulting response in the session window.

In certain embodiments, the “processing the feedback result into a resulting response in a target form and outputting the resulting response in the session window” in the first execution submodule and the second execution submodule includes at least one of the following units: a sixth output unit, a seventh output unit, an eighth output unit, and a ninth output unit, where the sixth output unit is used to process the feedback result into a resulting response in a target form corresponding to the attribute information based on the attribute information of the feedback result and output the resulting response in the main window and/or the extended window of the session window; the seventh output unit is used to process the feedback result into a resulting response in a target form based on the user portrait information of the target user and output the resulting response in the main window and/or the extended window of the session window; the eighth output unit is used to process the feedback result into a resulting response in a target form based on the data volume of the feedback result, and output the resulting response in the main window and/or the extended window of the session window; the ninth output unit is used to process the feedback result into a resulting response in a target form based on the working status of the electronic device and/or the first application, and output the resulting response in the main window and/or the extended window of the session window, and the electronic device is a device running the first application.

In certain embodiments, the first execution module 510 includes at least one of the following submodules: a fourth execution submodule, a fifth execution submodule, a sixth execution submodule, a seventh execution submodule, and an eighth execution submodule, where the fourth execution submodule is used to process the feedback result provided by the second application into a card or interface window with controls and display the card or interface window in the main window and/or the extended window of the session window when the first input content is used to configure the target component of the electronic device; the fifth execution submodule is used to process the feedback result provided by the third application and/or the first knowledge base into a thumbnail and/or a file list and display the thumbnail and/or file list in the main window and/or the extended window of the session window when the first input content is used to search for the target file; the sixth execution submodule is used to process the feedback result provided by the fourth application into an application list with controls and display the application list in the main window and/or extended window of the session window when the first input content is used to find the target application; the seventh execution submodule is used to process the feedback result provided by the second application and/or the second knowledge base into a card or configuration table and display the card or configuration table in the main window and/or extended window of the session window when the first input content is used to view the configuration information of the electronic device; and the eighth execution submodule is used to process the feedback result provided by the fifth application into a video animation and display the video animation in the main window and/or extended window of the session window when the first input content is used to migrate data and/or boot the electronic device.

In certain embodiments, the device/apparatus includes an updating module for, in response to obtaining the second input content, updating the resulting response in the session window and/or controlling the electronic device to perform a target operation in response to the second input content.

In certain embodiments, the update module includes at least one of the following submodules: a first update submodule, a second update submodule and a third update submodule, wherein the first update submodule is used to update the display state of the control in the session window and control the electronic device to perform a target operation corresponding to the input operation when the second input content includes an input operation on a control in a resulting response corresponding to the first input content; the second update submodule is used to update the display state and/or display content of the resulting response in the session window when the second input content has a first association relationship with the first input content; the third update submodule is used to regenerate a resulting response in the session window or control the electronic device to perform a corresponding target operation when the second input content has a second association relationship with the first input content.

In certain embodiments, the device includes a second execution module, which is used to display the target terminal device in the session window in response to establishing a connection with the target terminal device, to control the target terminal device to perform a corresponding operation based on the third input content acting in the session window, or to perform a corresponding response operation in response to a target execution from the target terminal device.

The description of the herein device embodiments is similar to the description of the herein method embodiments, and has similar beneficial effects as the method embodiments. For technical details not disclosed in the device embodiments of the present disclosure, one may refer to the description of the method embodiments of the present disclosure for additional or further understanding.

When the herein method is implemented in the form of a software function module and sold or used as an independent product, the method may also be stored in a computer-readable storage medium. The technical solution may be reflected in the form of a software product that contributes to the relevant technology. The computer software product is stored in a storage medium, including several instructions to enable an electronic device (which may be a mobile phone, tablet computer, laptop computer, desktop computer, or the like) to execute all or part of the method described in certain embodiments of the present disclosure. The aforementioned storage medium includes: various media that may store program codes, such as a U disk, a mobile hard disk, a read-only memory (ROM), a magnetic disk or an optical disk. Embodiments of the present disclosure are not limited to any specific combination of hardware and software.

The present disclosure in certain embodiments provides a storage medium on which a computer program is stored. When the computer program is executed by a processor, the steps in the human-computer interaction method provided in the herein embodiments are implemented.

The present disclosure in certain embodiments provides an electronic device, and FIG. 6 is a schematic diagram of a hardware entity of the electronic device. As shown in FIG. 6, the hardware entity of the device 600 includes: a memory 601 and a processor 602, the memory 601 stores a computer program that may be run on the processor 602, and the processor 602 implements the steps in the human-computer interaction method when executing the program.

The memory 601 is configured to store instructions and applications executable by the processor 602, and may also cache data to be processed or processed by the processor 602 and various modules in the electronic device 600 (in certain embodiments, image data, audio data, voice communication data, and video communication data), which may be implemented through flash memory (FLASH) or random access memory (Random Access Memory, RAM).

The description of the herein storage medium and device embodiments is similar to the description of the herein method embodiments, and has similar beneficial effects as the method embodiments. For technical details not disclosed in the storage medium and device embodiments, one may refer to the description of the method embodiments for additional or further understanding.

“One embodiment” or “an embodiment” or “certain embodiments” or “embodiments” mentioned herein refers to that specific features, structures or characteristics related to the embodiment are included in at least one embodiment of the present disclosure. Therefore, “in one embodiment” or “in an embodiment” or “in certain embodiments” or “in embodiments” appearing throughout herein does not necessarily refer to the same embodiment. In addition, these specific features, structures or characteristics may be combined in one or more embodiments in any suitable manner. In various embodiments of the present disclosure, the size of the sequence number of the herein-mentioned processes does not necessarily demand the order of execution, and the execution order of each process may be determined by function and internal logic, and should not constitute any limitation on the implementation process of the embodiments. The herein-mentioned sequence numbers of the embodiments of the present disclosure are only for description and do not necessarily represent the advantages and disadvantages of the embodiments.

Terms such as “include” and “comprise” or any other variations thereof are intended to cover non-exclusive inclusion, so that a process, method, article or device including a series of elements includes not only those elements, but also other elements not explicitly listed, or also includes elements inherent to such process, method, article or device. In the absence of further restrictions, an element defined by the term “include a” and “comprises a . . . ” does not necessarily exclude the existence of other identical elements in the process, method, article or device including the element.

The disclosed devices and methods may be implemented in other suitable ways. The device embodiments described herein are only schematic. In certain embodiments, the division of the units is only a logical function division. There may be other division methods in actual implementation, such as: multiple units or components may be combined, or may be integrated into another system, or some features may be ignored or not executed. In addition, the coupling, direct coupling, or communication connection between the components shown or discussed may be through some interfaces, and the indirect coupling or communication connection of the devices or units may be electrical, mechanical, or other forms.

The units described herein as separate components may or may not be physically separated, and the components displayed as units may or may not be physical units; they may be located in one place or distributed on multiple network units; some or all of the units may be selected according to actual needs to achieve the purpose of the present embodiment.

Functional units in the embodiments of the present disclosure may be integrated into one processing unit, or each unit may be separately configured as a unit, or two or more units may be integrated into one unit; the herein-mentioned integrated units may be implemented in the form of hardware or in the form of hardware plus software functional units.

All or part of the steps of implementing the herein method embodiments may be performed by hardware related to program instructions, and the herein-mentioned program may be stored in a computer-readable storage medium. When the program is executed, the program executes the steps of the herein method embodiments; and the herein-mentioned storage medium includes: a mobile storage device, a read-only memory (ROM), a disk or an optical disk, and other media that may store program codes.

When the herein-mentioned integrated unit of the present disclosure is implemented in the form of a software function module and sold or used as an independent product, the unit may also be stored in a computer-readable storage medium. The technical solution of the embodiments of the present disclosure may be reflected in the form of a software product that contributes to the relevant technology. The computer software product is stored in a storage medium, including several instructions for an electronic device (which may be a mobile phone, tablet computer, laptop computer, desktop computer, or the like) to execute all or part of the methods described herein according to certain embodiments of the present disclosure. The storage medium may include: various media that may store program codes, such as mobile storage devices, ROMs, magnetic disks or optical disks.

The method disclosed herein according to certain embodiments of the present disclosure may be arbitrarily combined without conflict to obtain new method embodiments.

The features disclosed in several product embodiments provided in the present disclosure may be arbitrarily combined without conflict to obtain new product embodiments.

The features disclosed in several method or device embodiments provided in the present disclosure may be arbitrarily combined without conflict to obtain new method embodiments or device embodiments.

Described herein is an implementation method of the present disclosure, but the protection scope of the present disclosure is not limited thereto. Those skilled in the technical field may easily think of changes or substitutions within the technical scope disclosed in the present disclosure, which should be included in the protection scope of the present disclosure. The protection scope of the present disclosure should be based on the protection scope of the accompanying claims.

What is claimed is:

1. A human-computer interaction method, comprising:
in response to obtaining a first input content, outputting a resulting response corresponding to the first input content in a session window of a first application executing an interactive task;
wherein a presentation mode or operability of the resulting response varies with the first input content.

2. The method of claim 1, wherein outputting the resulting response comprises one or both of:
identifying a user intent represented by the first input content, obtaining a feedback result provided by a target application or target knowledge base for the user intent, processing the feedback result into a resulting response in a target form and outputting the resulting response in the session window; or
obtaining the feedback result corresponding to the first input content from the target application or target knowledge base through a target interface, processing the feedback result into the resulting response in the target form and outputting the resulting response in the session window,
wherein the target application is an application that establishes a target association relationship with the first application, and the target knowledge base includes a local knowledge base and/or cloud knowledge base of the first application.

3. The method of claim 2, further comprising:
determining the target application or target knowledge base that corresponds to the first input content, loading a target response component of the target application or the target knowledge base into the first application, so that the feedback result is processed into the resulting response in the target form and the resulting response is displayed in the session window through the target response component, wherein determining the target application or target knowledge base includes one or more of:
identifying a target keyword in the first input content, and determining the target application or target knowledge base based on the target keyword;
obtaining user portrait data of a target user who inputs the first input content, and determining the target application or target knowledge base based on the user portrait data;
determining the target application or target knowledge base based on a user intent represented by the first input content; or
determining the target application or target knowledge base based on the first input content and configuration information of an electronic device running the first application.

4. The method of claim 2, wherein processing the feedback result into the resulting response comprises one or more of:
using a target response component of the target application or the target knowledge base to process the feedback result into the resulting response in a card form and outputting the resulting response in the session window;
processing the feedback result into the resulting response in a control form and outputting the resulting response in the session window;
processing the feedback result into the resulting response in a snapshot form and outputting the resulting response in the session window;
processing the feedback result into the resulting response in a hyperlink form and outputting the resulting response in the session window; or
processing the feedback result into the resulting response in a file library form and outputting the resulting response in the session window.

5. The method of claim 2, wherein processing the feedback result into the resulting response comprises one or more of:
based on attribute information of the feedback result, processing the feedback result into the resulting response in a target form corresponding to the attribute information and outputting the resulting response in a main window and/or an extended window of the session window;
based on user portrait information of a target user, processing the feedback result into the resulting response in a target form corresponding to the user portrait information and outputting the resulting response in the main window and/or the extended window of the session window;
based on a data volume of the feedback result, processing the feedback result into the resulting response in a target form corresponding to the data volume and outputting the resulting response in the main window and/or the extended window of the session window; or
based on a working status of an electronic device and/or the first application, processing the feedback result into the resulting response in a target form corresponding to the working status and outputting the resulting response in the main window and/or extended window of the session window, the electronic device being a device running the first application.

6. The method of claim 1, wherein outputting of the resulting response comprises one or more of:
in response to the first input content being used to configure a target component of an electronic device, processing the feedback result provided by a second application into a card or interface window with controls and displaying the card or interface window in a main window and/or an extended window of the session window;
in response to the first input content being used to search for a target file, processing the feedback result provided by a third application and/or a first knowledge base into a thumbnail and/or a file list and displaying the thumbnail and/or the file list in the main window and/or extended window of the session window;
in response to the first input content being used to find the target application, processing the feedback result provided by a fourth application into an application list with controls and displaying the application list in the main window and/or extended window of the session window;
in response to the first input content being used to view configuration information of an electronic device, processing the feedback result provided by a second application and/or a second knowledge base into a card or configuration table and displaying the card or configuration table in the main window and/or extended window of the session window; or
in response to the first input content being used to migrate data and/or boot the electronic device, processing the feedback result provided by a fifth application into a video animation and displaying the video animation in the main window and/or extended window of the session window.

7. The method of claim 1, further comprising:
in response to obtaining the second input content, updating the resulting response in the session window and/or controlling an electronic device to perform a target operation in response to the second input content.

8. The method of claim 7, wherein updating of the resulting response in the session window and/or controlling the electronic device comprises one or more of:
in response to that the second input content includes an input operation acting on a control in the resulting response corresponding to the first input content, updating a display state of the control in the session window and controlling the electronic device to perform a target operation corresponding to the input operation;
in response to that the second input content has a first association relationship with the first input content, updating the display state and/or display content of the resulting response in the session window; or
in response to that the second input content has a second association relationship with the first input content, regenerating the resulting response in the session window or controlling the electronic device to perform the target operation.

9. The method of claim 1, further comprising:
in response to establishing a connection with a target terminal device, displaying and outputting the target terminal device in the session window, to control the target terminal device to perform a corresponding operation based on a third input content acting in the session window; or
in response to a target from the target terminal device, performing a corresponding response operation.

10. A human-computer interaction device, comprising a first execution module for:
outputting a resulting response corresponding to a first input content in a session window of a first application executing an interactive task in response to obtaining the first input content, wherein a presentation method or operability of the resulting response varies with the first input content.

11. An electronic device, comprising a memory storing computer program instructions; and one or more processors coupled to the memory and configured to execute the computer program instructions and perform:
in response to obtaining a first input content, outputting a resulting response corresponding to the first input content in a session window of a first application executing an interactive task;
wherein a presentation mode or operability of the resulting response varies with the first input content.

12. The electronic device of claim 11, wherein outputting the resulting response includes one or both of:
identifying a user intent represented by the first input content, obtaining a feedback result provided by a target application or target knowledge base for the user intent, processing the feedback result into a resulting response in a target form and outputting the resulting response in the session window; or
obtaining the feedback result corresponding to the first input content from the target application or target knowledge base through a target interface, processing the feedback result into the resulting response in the target form and outputting the resulting response in the session window,
wherein the target application is an application that establishes a target association relationship with the first application, and the target knowledge base includes a local knowledge base and/or cloud knowledge base of the first application.

13. The electronic device of claim 12, wherein the method further includes:
determining the target application or target knowledge base that corresponds to the first input content, loading a target response component of the target application or the target knowledge base into the first application, so that the feedback result is processed into the resulting response in the target form and the resulting response is displayed in the session window through the target response component.

14. The electronic device of claim 13, wherein determining the target application or target knowledge base includes:
identifying a target keyword in the first input content, and determining the target application or target knowledge base based on the target keyword;
obtaining user portrait data of a target user who inputs the first input content, and determining the target application or target knowledge base based on the user portrait data;
determining the target application or target knowledge base based on a user intent represented by the first input content; or
determining the target application or target knowledge base based on the first input content and configuration information of an electronic device running the first application.

15. The electronic device of claim 13, wherein determining the target application or target knowledge base includes:
identifying a target keyword in the first input content, and determining the target application or target knowledge base based on the target keyword.

16. The electronic device of claim 13, wherein determining the target application or target knowledge base includes:
obtaining user portrait data of a target user who inputs the first input content, and determining the target application or target knowledge base based on the user portrait data.

17. The electronic device of claim 13, wherein determining the target application or target knowledge base includes:
determining the target application or target knowledge base based on a user intent represented by the first input content.

18. The electronic device of claim 13, wherein determining the target application or target knowledge base includes:
determining the target application or target knowledge base based on the first input content and configuration information of an electronic device running the first application.

19. The electronic device of claim 12, wherein processing the feedback result into the resulting response includes one or more of:
using a target response component of the target application or the target knowledge base to process the feedback result into the resulting response in a card form and outputting the resulting response in the session window;
processing the feedback result into the resulting response in a control form and outputting the resulting response in the session window;
processing the feedback result into the resulting response in a snapshot form and outputting the resulting response in the session window;
processing the feedback result into the resulting response in a hyperlink form and outputting the resulting response in the session window; or
processing the feedback result into the resulting response in a file library form and outputting the resulting response in the session window.

20. The electronic device of claim 12, wherein processing the feedback result into the resulting response includes one or more of:
based on attribute information of the feedback result, processing the feedback result into the resulting response in a target form corresponding to the attribute information and outputting the resulting response in a main window and/or an extended window of the session window;
based on user portrait information of a target user, processing the feedback result into the resulting response in a target form corresponding to the user portrait information and outputting the resulting response in the main window and/or the extended window of the session window;
based on a data volume of the feedback result, processing the feedback result into the resulting response in a target form corresponding to the data volume and outputting the resulting response in the main window and/or the extended window of the session window; or
based on a working status of an electronic device and/or the first application, processing the feedback result into the resulting response in a target form corresponding to the working status and outputting the resulting response in the main window and/or extended window of the session window, the electronic device being a device running the first application.
